(19) United States
(12) Patent Application Publication
(10) Pub. No.: US 2026/0364732 A1
(43) Pub. Date: Nov. 19, 2026

(54) Quick-Change Working Head Releasably Attachable to a Front Part of a Tool Housing of a Hand-Held Power Tool and Hand-Held Power Tool with such a Quick- Change Working Head

(71) Applicant: Andrea VALENTI, Milano (IT)

(72) Inventor: Andrea Valentini, Milano (IT)

(21) Appl. No.: 19/396,897

(22) Filed: Nov. 21, 2025

(30) Foreign Application Priority Data
Feb. 3, 2025 (EP) 25155530.6

(51) Int. Cl. B24B 23/02; B24B 41/00; B24B 45/00; B24B 47/12

(52) U.S. Cl. CPC B24B 23/028; B24B 41/002; B24B 45/006; B24B 47/12

(57) ABSTRACT

The invention refers to a hand-held power tool (10) having a tool housing (16) and a quick-change working head (50) releasably attachable to a front part (16b) of the tool housing (16). The working head (50) comprises an axial input adapter (52) connectable to a tool shaft (18) of the power tool (10), an axial output adapter (54) connectable to a working element (12) of the power tool (10) and a transmission arrangement (56) with a specific transmission ratio (i), functionally located between the axial input adapter (52) and the axial output adapter (54) and making the axial output adapter (54) rotate at a given speed depending on the rotational speed of the axial input adapter (52) and the transmission ratio (i) of the transmission arrangement (56). It is suggested that the working head (50) comprises magnetic elements (58) and the front part (16b) of the tool housing (16) comprises respective magnetic elements (60). The magnetic elements (58) magnetically interact with the respective magnetic elements (60) once the working head (50) is close to the front part (16b) of the tool housing (16). The magnetic interaction between the magnetic elements (58) and the respective magnetic elements (60) ensures that the working head (50) is firmly held in respect to the front part (16b) of the tool housing (16) in an axial direction extending parallel to a rotational axis (30) of the axial input adapter (52).

The present invention refers to a quick-change working head, which is releasably attachable to a front part of a tool housing of a hand-held power tool, in particular a polisher or sander. The working head comprises an axial input adapter releasably connectable to a tool shaft of the power tool, an axial output adapter releasably connectable to a working element, in particular a backing plate, of the power tool and a transmission arrangement with a specific transmission ratio, the transmission arrangement functionally located between the axial input adapter and the axial output adapter and adapted to make the axial output adapter rotate at a given speed depending on the rotational speed of the axial input adapter and the transmission ratio of the transmission arrangement.

The invention further refers to a hand-held power tool, in particular a polisher or sander, having a tool housing and a quick-change working head of the above-mentioned kind, which is releasably attachable to a front part of the tool housing of the power tool.

A quick-change working head as well as a hand-held power tool of the above-mentioned kind is known in the prior art, for example in the form of a cordless rotary and orbital polisher named ShineMate EB210 (https://shinemate.com/products/info/73.html) offered and sold by K & FP Limited, Flat/RM 13-15 19/F, Nan Fung Centre, 264-298 Castle Road, Tsuen Wan, Hong Kong.

A quick-change working head as well as a hand-held power tool of the above-mentioned kind in the form of the so-called “Giraffe” manufactured and sold by FLEX Elektrowerkzeuge GmbH, 71711 Steinheim/Murr (DE) is also known from and described in detail in EP 1 719 581 A1. Similar working heads and power tools are also known from DE 198 15 443 C1,

All known quick-change working heads and known hand-held power tools have in common that the attachment of the working head to the front part of the power tool is accomplished by means of a mechanical connection. This mechanical connection may be a bayonet connection or a snap-in connection just to name a few. The mechanical connections of the known working heads have the disadvantage that attaching or detaching the working head to/from the front part of the tool housing can be very time-consuming and complicated. Therefore, it is an object of the present invention to facilitate and accelerate attaching and detaching the working head to/from the front part of the tool housing.

This object is solved by a quick-change working head comprising the features of claim 1. In particular, starting from the quick-change working head of the above-identified kind, it is suggested that the working head comprises magnetic elements including one or more permanent magnets and/or one or more ferromagnetic elements. The magnetic elements are adapted to magnetically interact with respective magnetic elements including one or more permanent magnets and/or one or more ferromagnetic elements located in the front part of the tool housing of the hand-held power tool. The magnetic interaction between the magnetic elements of the working head and the respective magnetic elements of the front part of the tool housing is achieved once the working head is close to the front part of the tool housing during attachment of the working head to the front part of the tool housing of the power tool. The magnetic interaction ensures that the working head is firmly held in respect to the front part of the tool housing in an axial direction extending parallel to the rotational axis of the axial input adapter or the tool shaft, respectively.

The object of the present invention is also solved by a hand-held power tool comprising the features of claim 11. In particular, starting from the hand-held power tool of the above-identified kind, it is suggested that the working head comprises magnetic elements including one or more permanent magnets and/or one or more ferromagnetic elements, and the front part of the tool housing of the hand-held power tool comprises respective magnetic elements including one or more permanent magnets and/or one or more ferromagnetic elements. The magnetic elements are adapted to magnetically interact with the respective magnetic elements once the working head is close to the front part of the tool housing during attachment of the working head to the front part of the tool housing of the power tool. The magnetic interaction between the magnetic elements of the working head and the respective magnetic elements of the front part of the tool housing ensures that the working head is firmly held in respect to the front part of the tool housing in an axial direction extending parallel to a rotational axis of the axial input adapter or the tool shaft, respectively.

Preferably, the working head has an adapter housing in which the axial input adapter, the axial output adapter and the transmission arrangement are rotatably mounted. The adapter housing of the working head is firmly held in respect to the front part of the tool housing of the power tool in the axial direction by means of the magnetic interaction or the magnetic force, respectively, between the magnetic elements of the working head and the respective magnetic elements of the front part of the tool housing. When firmly held by magnetic force in respect to the tool housing, the adapter housing cannot be rotated in respect to the tool housing about the rotational axis of the axial input adapter or the tool shaft, respectively, i.e., the adapter housing is fastened to the tool housing in a torsion-resistant manner.

The working head is releasably held in the axial direction in respect to the front part of the tool housing. In order to release the working head from the tool housing, the working head is pulled in the axial direction away from the tool housing, thereby overcoming the magnetic forces acting between the magnetic elements of the working head and the respective magnetic elements of the tool housing. The respective magnetic elements are preferably located at or in a surface of the front part of the tool housing facing the working head when attached to the front part of the tool housing. Similarly, the magnetic elements of the working head are preferably located at or in a surface of the working head facing the front part of the tool housing when the working head is attached to the front part of the tool housing.

According to a preferred embodiment of the present invention it is suggested that the working head comprises mechanical positioning means being adapted to mechanically interact with respective mechanical positioning means located in the front part of the tool housing of the hand-held power tool once the working head is attached to the front part of the tool housing of the power tool, wherein the mechanic interaction between the mechanical positioning means of the working head and the respective mechanical positioning means of the front part of the tool housing holds the working head in respect to the front part of the tool housing in a circumferential direction extending in a plane extending perpendicular to the rotational axis of the axial input adapter or the tool shaft, respectively, in a specific angular position. The mechanical positioning means also prevent a rotation of the working head in the circumferential direction in respect to the front part of the tool housing, once the working head is attached to the front part of the tool housing and held in the axial direction by means of the magnetic force.

At least some of the mechanical positioning means of the working head and/or at least some of the respective mechanical positioning means of the front part of the tool housing of the power tool may comprise one or more initial guiding portions which facilitate entering into mechanical contact with each other. Thereafter, the initial guiding portions may—upon further axial movement of the working head towards the front part of the tool housing—guide the working head into an attachment position in respect to the front part of the tool housing. Preferably, in the attachment position the magnetic elements of the working head and the respective magnetic elements of the front part of the tool housing face each other and are located opposite to each other so that a maximum magnetic force is established between the magnetic elements of the working head and the respective magnetic elements of the front part of the tool housing. Thus, the mechanical positioning means facilitate and accelerate the process of attaching the working head to the front part of the tool housing.

It is further suggested that the mechanical positioning means of the working head and the respective mechanical positioning means of the front part of the tool housing have an exclusively axial extension extending parallel to the rotational axis of the axial input adapter or the tool shaft, respectively. Thus, the guided movement of the working head towards the front part of the tool housing into the attachment position is strictly linear in the axial direction. Of course, it would also be possible that the guided movement has a different form, e.g., is helical or forms part of a helical revolution of the working head in respect to the front part of the tool housing.

According to another preferred embodiment of the invention it is suggested that the transmission arrangement has a transmission ratio i of i>1, in particular of i>1,5, particularly preferred of i≥2, in particular of i=2,36, thereby reducing speed and increasing torque of the axial output adapter in respect to the speed and torque of the axial input adapter. This is particularly advantageous if due to spatial restrictions inside the tool housing only small electric motors, in particular electric motors having a rather small external diameter, can be used which generally produce less torque than larger electric motors. Even with such smaller electric motors a sufficiently large amount of torque can be generated provided that the electric motor rotates at a speed large enough. For instance, with the transmission arrangement having a ratio of i=2 and the electric motor having a maximum speed of approximately 5.000 rpm, the axial output adapter or the backing plate attached thereto may rotate at a maximum of 2.500 rpm and at the same time generate sufficient torque to polish or sand a desired working surface or workpiece, respectively. The transmission arrangement may be designed such as to reduce the rotational speed of the output adapter in respect to the rotational speed of the input adapter, and at the same time to change the type or motion executed by the axial output adapter. For instance, the tool shaft and the axial input adapter may perform a rotational motion and the axial output adapter may perform one of a gear driven (or forced eccentric) motion, a random-orbital (or free eccentric) and an orbital motion.

Of course, the transmission arrangement may also have a transmission ratio i of i=1 or of i<1. In the case of i=1, the transmission arrangement is designed such as to maintain the rotational speed of the input adapter and to merely change the type or motion executed by the axial output adapter. For instance, the tool shaft and the axial input adapter may perform a rotational motion and the axial output adapter may perform one of a gear driven (or forced eccentric) motion, a random-orbital (or free eccentric) and an orbital motion.

In the case of i<1, the transmission arrangement may be designed such as to increase the rotational speed of the axial output adapter in respect to the speed of the axial input adapter. At the same time, the torque generated by the output adapter and provided to the backing plate, respectively, is smaller than the torque generated by the tool shaft and the input adapter, respectively. This may be particularly interesting for high-speed applications which do not need a large amount of torque. The transmission arrangement may be designed such as to increase the rotational speed of the output adapter in respect to the rotational speed of the input adapter, and at the same time to change the type or motion executed by the axial output adapter. For instance, the tool shaft and the axial input adapter may perform a rotational motion and the axial output adapter may perform one of a gear driven (or forced eccentric) motion, a random-orbital (or free eccentric) and an orbital motion.

Preferably, the transmission arrangement is designed such as to transform a rotary motion of the axial input shaft into a rotary motion of the axial output shaft at a rotational speed differing from the rotational speed of the axial input shaft, wherein the rotational axes of the axial input shaft and of the axial output shaft are congruent with one another. Thus, the transmission arrangement is designed such as to maintain the type of motion of the axial input shaft and to simply transfer it to the axial output shaft. Preferably, the rotary speed of the axial output shaft is smaller than the rotary speed of the axial input shaft, i.e., the transmission ratio i of the transmission arrangement is i>1, and the torque provided by the axial output shaft and provided to the backing plate is larger than the torque provided by the tool shaft of the power tool and the axial input shaft of the working head, respectively.

Preferably, the transmission arrangement is designed such as to transform the rotary motion of the axial input shaft into the rotary motion of the axial output shaft having the same sense of rotation as the axial input shaft.

Furthermore, it is suggested that the axial input adapter of the working head comprises an axial recess having a non-rotationally symmetric internal cross section including a polygon, in particular in the form of a square, a hexagon or an octagon. The tool shaft of the power tool comprises a shaft-like distal end having a respective non-rotationally symmetric external cross section including a polygon, in particular in the form of a square, a hexagon or an octagon. The axial recess of the axial input adapter of the working head is adapted to receive the shaft-like distal end of the tool shaft of the power tool in the axial direction, in order to establish a torque-proof connection between the tool shaft and the axial input adapter.

Alternatively, it is suggested that the axial input adapter of the working head comprises a shaft-like protruding element having a non-rotationally symmetric external cross section including a polygon, in particular in the form of a square, a hexagon or an octagon. The tool shaft of the power tool comprises an axial recess having a respective non-rotationally symmetric internal cross section including a polygon, in particular in the form of a square, a hexagon or an octagon. The shaft-like protruding element of the axial input adapter of the working head is adapted to enter into the axial recess of the distal end of the tool shaft of the power tool in the axial direction, in order to establish a torque-proof connection between the tool shaft and the axial input adapter.

Preferably, when attaching the working head to the tool housing the axial input adapter automatically enters into engagement with the distal end of the tool shaft in a torque proof manner. Thus, when the adapter housing of the working head is firmly held in respect to the front part of the tool housing (in a torque-resistant manner) by means of magnetic force, a torque can be transmitted from the tool shaft of the power tool to the input adapter of the working head. Attachment and detachment of the working head is straight forward, easy and fail-safe.

According to another preferred embodiment of the quick-change working head according to the present invention it is suggested that the axial output adapter of the working head comprises an axial recess having a threaded internal wall. A fastening pin is attached to a top surface of the backing plate. A shaft-like distal end of the fastening pin has a threaded external surface. The axial recess is adapted to receive in a threaded manner the distal end of the fastening pin, in order to establish a threaded connection between the backing plate and the axial output adapter. When attaching or detaching the backing plate to/from the axial output adapter, free rotation of the output adapter should be prevented. This could be achieved by means of a separate tool member insertable into the working head and blocking free rotation of the axial output adapter, or by means of an integrated braking or blocking device which can be activated or deactivated by the user of the working head or the power tool, respectively. The braking or blocking device could make part of the working head.

Alternatively, it is suggested that the axial output adapter of the working head comprises a fastening pin having a shaft-like distal end with a threaded external surface. An axial recess is provided on a top surface of the backing plate, the recess having a respective threaded internal wall. The shaft-like distal end of the fastening pin is adapted to be inserted in a threaded manner into the axial recess of the backing plate, in order to establish a threaded connection between the backing plate and the axial output adapter.

Further features and advantages of the present invention will become apparent from the following description referring to the accompanying drawings. It is emphasized that each feature shown in the drawings can be essential on its own for the present invention even if not explicitly mentioned in the description. Further, the features shown in the various drawings may be combined in any desired manner even if such a combination is not explicitly shown in the figures and described in the description. The figures show:

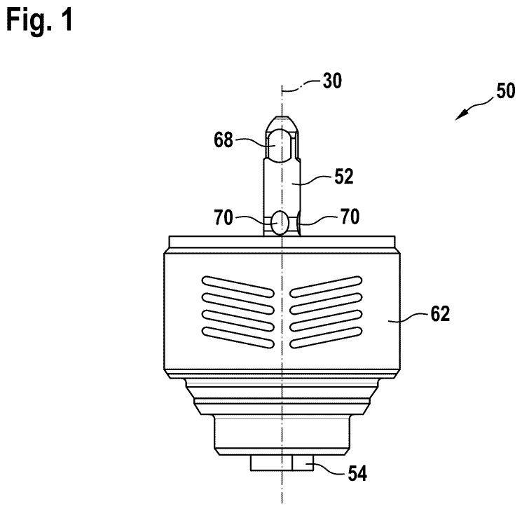

FIG. 1 a quick-change working head according to the present invention in a side view;

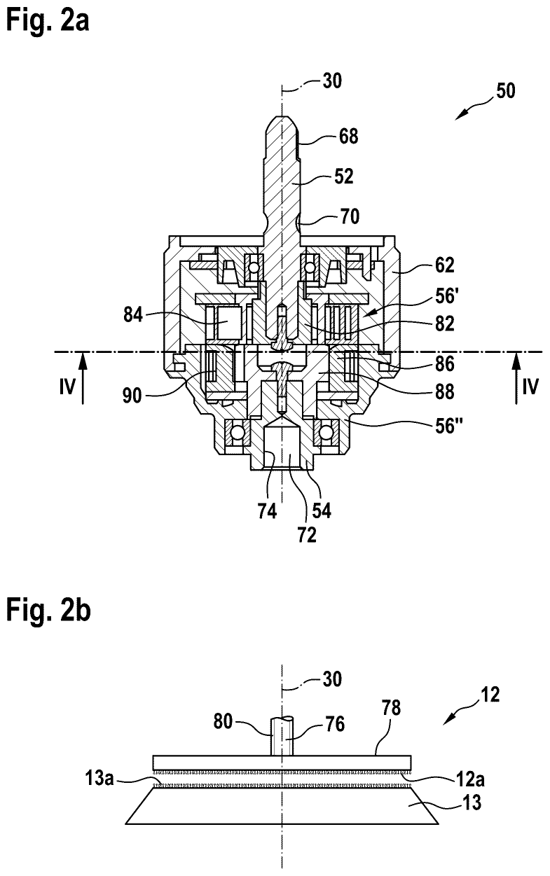

FIG. 2a the quick-change working head of FIG. 1 in a sectional side view transverse to a vertical centre axis;

FIG. 2b an example of a backing plate for attachment to an axial output adapter of the working head;

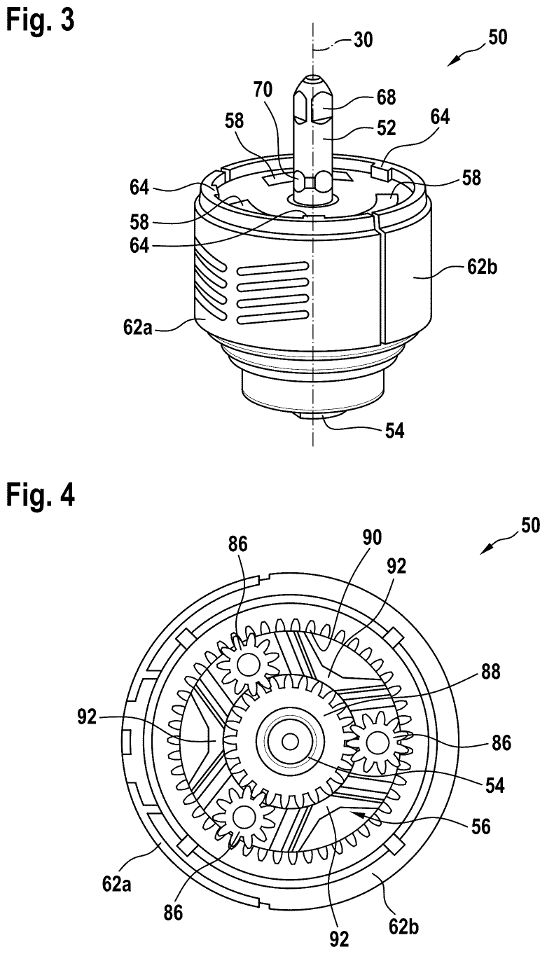

FIG. 3 the quick-change working head of FIG. 1 in a perspective view;

FIG. 4 the quick-change working head of FIG. 1 in a bottom view along a section IV-IV in FIG. 2a;

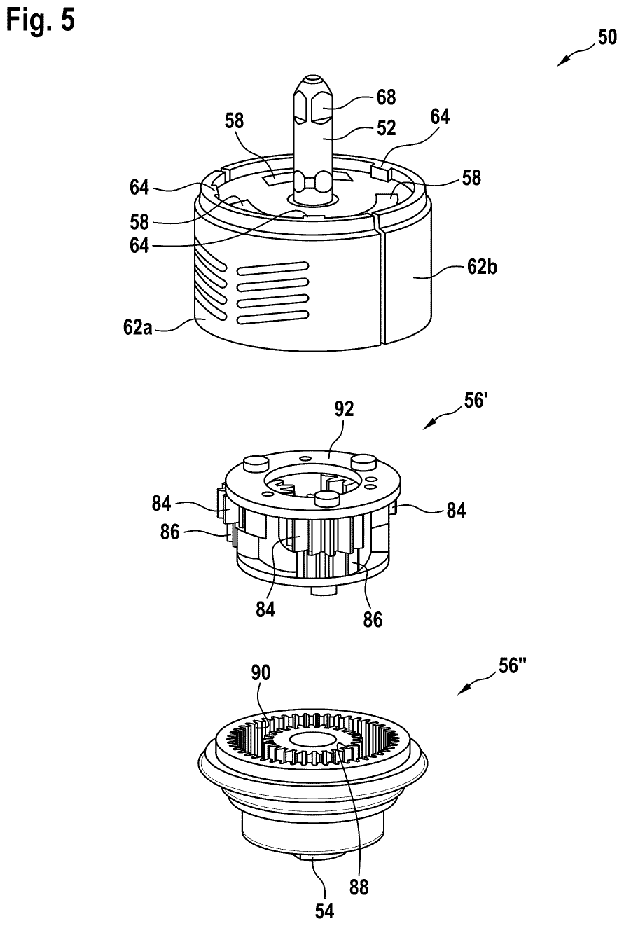

FIG. 5 the quick-change working head of FIG. 1 partly disassembled in an exploded view; and

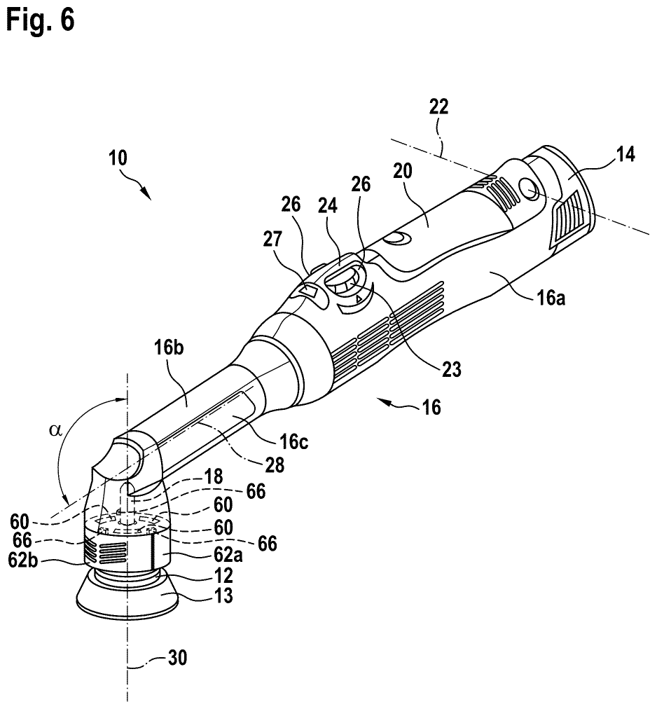

FIG. 6 a hand-held power tool in the form of a polisher or a sander according to the present invention having a quick-change working head according to the present invention; and

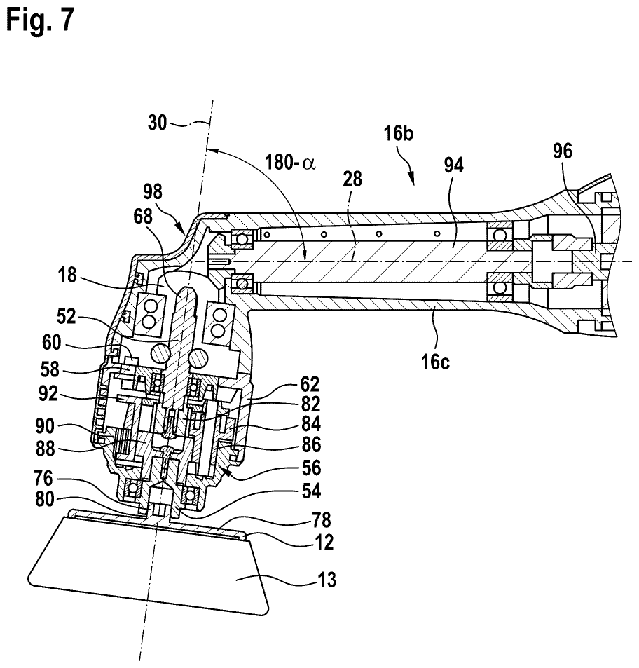

FIG. 7 a front part of the power tool of FIG. 6 in a sectional view.

FIG. 6 shows a hand-held power tool 10 in the form of a polisher or a sander according to the present invention. Design and functioning of the power tool 10 are similar to what is described in respect to the power tool known from prior art reference EP 3 012 068 A1, which is incorporated herein by reference as far as design and functioning of the power tool 10 are concerned. The power tool 10 is a so-called mini-or nano-polisher or sander due to its rather small dimensions and its ability to reach small and cramped spaces for working a working surface in these spaces. The power tool 10 is primarily used for the so-called spot repair of vehicle bodies, boat and aircraft hulls. Depending on the various functional units attached to a tool shaft 18 of the power tool 10 and the resulting motion of a working element 12 (e.g., a backing plate) of the power tool 10, it may be used for various sanding and/or polishing tasks. Due to its operation by means of an extractable battery 14, the power tool 10 can be operated independent form a mains power supply with the need for a cable connecting it to the mains power supply.

Various types of polishing members 13 or sanding members may be releasably attached to a bottom surface of the backing plate 12. As shown in FIG. 2b, it is suggested that the bottom surface of the backing plate 12 is provided with a first sheet of an attachment member 12a, e.g., a first sheet of a hook-and-loop fastener (e.g., hooks), and a top surface of the polishing member 13 or the sanding member is provided with a second sheet of the attachment member 13a, e.g., a second sheet of the hook-and-loop fastener (e.g., loops). The first and second sheets of the attachment members 12a, 13a interact with each other in order to hold the polishing member 13 or sanding member on the bottom surface of the backing plate 12. Instead of a hook-and-loop fastener, the sheets of attachment member 12a, 13a could also comprise adhesive surfaces or the like.

The power tool 10 has a tool housing 16 essentially made up of a rear part 16a for holding the power tool 10 with the hand of a user and a front part 16b of smaller diameter than the rear part 16a. The diameter of the front part 16b is so small in order to reach the small and cramped spaces for working a working surface in these spaces. An electric motor (not shown) operated by the battery 14 and possibly other electric components are located inside the tool housing 16. The electric motor serves for driving the working element 12. A motor shaft 96 (see FIG. 7) of the electric motor may be attached to the tool shaft 18 of the power tool 10 by means of an intermediate shaft 94 and/or gear transmissions 98, for instance a bevel gear. The tool shaft 18 is located in the front part 16b of the tool housing 16 and is accessible form outside the tool housing 16, in the embodiment of FIG. 6 from below.

The power tool 10 has an activation lever 20 located on the top side of the rear part 16a of the tool housing 16. The lever 20 is connected to an on/off switch (not shown) for turning on and off the electric motor. The lever 20 may be swivelled about a swivelling axis 22 and may be actuated by the palm of a user's hand holding the power tool 10 at the rear part 16a of the tool housing 16. Of course, the activation lever 20 could also be located on the bottom side of the rear part 16a of the tool housing 16 where it could be actuated by one or more fingers of a user's hand holding the power tool 10 at the rear part 16a of the tool housing 16. Alternatively, instead of an activation lever 20, the tool housing 16 could be provided with a respective switch, e.g., a sliding switch, for turning on and off the electric motor.

The power tool 10 has a rotary switch 23 located on the top side of the rear part 16a of the tool housing 16. The rotary switch 23 is connected to a potentiometer (not shown) for increasing and/or reducing the speed of the electric motor. The rotary switch 23 is located inside a bulge 24 in the tool housing 16 at the top, with lateral openings 26 permitting access to the rotary switch 23 from the sides by means of thumb and index finger of a user's hand holding the power tool 10. Of course, the rotary switch 23 could also be located at different locations of the tool housing 16. Instead of the rotary switch 23, the power tool 10 could be equipped with push buttons (not shown), e.g., one marked “+” for increasing the speed of the electric motor and another one marked “−” for reducing the speed.

A visual indication 27, e.g., in the form of one or more LEDs, may be provided at a given location in the tool housing 16. In the embodiment of FIG. 6, the visual indication 27 is located on the top surface of the rear part 16a of the tool housing 16 in front of the rotary switch 23, in particular on a front wall of the bulge 24. The visual indication 27 may indicate the operational status of one or more components of the power tool 10, e.g., a charging level of the battery 24. The visual indication 27 may comprises one or more LEDs emitting light in different colours, e.g., in green, yellow and red. The visual indication 27 may comprises one or more LEDs emitting light in various lighting modes, e.g., continuously emitting light, intermittently emitting light at one or more intermittent frequencies.

The rear part 16a of the tool housing 16 is preferably made of a plastic material. The front part 16b of the housing 16 may be made of metal or a plastic material. Preferably, the front part 16b of the housing 16 is made of the same plastic material than the rear part 16a. The front part 16b of the tool housing 16 has a tube-like section 16c, which corresponds to the majority of the longitudinal extension of the front part 16b of the housing 16. Preferably, the tube-like section 16c contains an intermediate shaft 94 (see FIG. 7) interconnecting the motor shaft 96 of the electric motor with a bevel gear 98 in the front part 16b of the tool housing 16. The bevel gear 98 translates a rotational motion of the intermediate shaft 94 about its rotational axis 28 into a rotational motion of the tool shaft 18 about its rotational axis 30. The rotational axes 28, 30 extend in an angle a in respect to each other, with preferably 90°≤a≤120°, in particular a=97° or 98°.

The power tool 10 according to the invention has a quick-change working head 50 releasably attached to the front part 16b of the tool housing. The working head 50 is shown in more detail in FIGS. 1 to 5. It comprises an axial input adapter 52 releasably connectable to the tool shaft 18 of the power tool 10, an axial output adapter 54 releasably connectable to the working element 12, e.g., the backing plate, of the power tool 10 and a transmission arrangement 56 (see FIGS. 2, 4 and 5) with a specific transmission ratio i, the transmission arrangement 56 functionally located between the axial input adapter 52 and the axial output adapter 54 and adapted to make the axial output adapter 54 rotate at a given speed depending on the rotational speed of the axial input adapter 52 and the transmission ratio i of the transmission arrangement 56.

The working head 50 comprises magnetic elements 58 (see FIG. 3) including one or more permanent magnets and/or one or more ferromagnetic elements, the magnetic elements 58 being adapted to magnetically interact with respective magnetic elements 60 (see FIG. 6) including one or more permanent magnets and/or one or more ferromagnetic elements located in the front part 16b of the tool housing 16 of the hand-held power tool 10, once the working head 50 is close to the front part 16b of the tool housing 16 during attachment of the working head 50 to the front part 16b of the tool housing 16 of the power tool 10. The magnetic interaction between the magnetic elements 58 of the working head 50 and the respective magnetic elements 60 of the front part 16b of the tool housing 16 ensures that the working head 50 is firmly held in respect to the front part 16b of the tool housing 16 in an axial direction extending parallel to the rotational axis 30 of the axial input adapter 52. In the embodiments of the working heads 50 shown in FIGS. 1 to 5, the rotational axis of the axial input adapter 52 is congruent with the rotational axis 30 of the tool shaft 18 of the power tool 10, when the working head 50 is attached to the front part 16b of the tool housing 16 of the power tool 10.

The working head 50 of the example has an adapter housing 62 in which the axial input adapter 52, the axial output adapter 54 and the transmission arrangement 56 are rotatably mounted. The adapter housing 62 of the working head 50 is firmly held in respect to the front part 16b of the tool housing 16 of the power tool 10 in the axial direction by means of the magnetic interaction or the magnetic force, respectively, between the magnetic elements 58 of the working head 50 and the respective magnetic elements 60 of the front part 16b of the tool housing 16. When firmly held by magnetic force in respect to the tool housing 16, the adapter housing 62 cannot be rotated in respect to the tool housing 16 about the rotational axis 30 of the axial input adapter 52, i.e., the adapter housing 62 is fastened to the tool housing 16 in a torsion-resistant manner.

The working head 50 may comprise mechanical positioning means 64 (see FIG. 3) being adapted to mechanically interact with respective mechanical positioning means 66 (see FIG. 6) located in the front part 16b of the tool housing 16 of the hand-held power tool 10 once the working head 50 is attached to the front part 16b of the tool housing 16 of the power tool 10. The mechanic interaction between the mechanical positioning means 64 of the working head 50 and the respective mechanical positioning means 66 of the front part 16b of the tool housing 16 holds the working head 50 in respect to the front part 16b of the tool housing 16 in a circumferential direction extending in a plane extending perpendicular to the rotational axis 30 of the axial input adapter 52 in a specific angular position. Although present in FIG. 6, for the sake of clarity the axial input adapter 52, the magnetic elements 58 and the mechanical positioning means 64 of the working head 50 are not explicitly shown.

At least some of the mechanical positioning means 64 of the working head 50 and/or at least some of the respective mechanical positioning means 66 of the front part 16b of the tool housing 16 of the power tool 10 may comprise one or more initial guiding portions (not shown) which facilitate entering into mechanical contact with each other. Upon further axial movement of the working head 50 towards the front part 16b of the tool housing 16, the initial guiding portions or the remining part of the mechanical positioning means 64 may guide the working head 50 into an attachment position in respect to the front part 16b of the tool housing 16. Preferably, in the attachment position the magnetic elements 58 of the working head 50 and the respective magnetic elements 60 of the front part 16b of the tool housing 16 face each other and are located opposite to each other so that a maximum magnetic force is established between the magnetic elements 58 of the working head 50 and the respective magnetic elements 60 of the front part 16b of the tool housing 16. Thus, the mechanical positioning means 64, 66 facilitate and accelerate the process of attaching the working head 50 to the front part 16b of the tool housing 16.

It is suggested that the mechanical positioning means 64 of the working head 50 and the respective mechanical positioning means 66 of the front part 16b of the tool housing 16 have an exclusively axial extension extending parallel to the rotational axis 30 of the axial input adapter 52. Thus, the guided movement of the working head 50 towards the front part 16b of the tool housing 16 into the attachment position is strictly linear in the axial direction. Of course, it would also be possible that the guided movement has a different form, e.g., is helical or forms part of a helical revolution of the working head 50 in respect to the front part 16b of the tool housing 16.

It is further suggested that the transmission arrangement 56 has a transmission ratio i of i>1, in particular of i>1,5, particularly preferred of i≥2, in particular of i=2,36, thereby reducing speed and increasing torque of the axial output adapter 54 in respect to the speed and torque of the axial input adapter 52. This is particularly advantageous if due to spatial restrictions inside the tool housing 16 only small electric motors, in particular electric motors having a rather small external diameter, can be used which generally produce less torque than larger electric motors. Even with such smaller electric motors a sufficiently large amount of torque can be generated at the working element 12 provided that the electric motor rotates at a speed large enough. For instance, with the transmission arrangement 56 having a ratio of i=2 and the electric motor having a maximum speed of approximately 5.000 rpm, the axial output adapter 54 or the backing plate 12 attached thereto may rotate at a maximum of 2.500 rpm and at the same time generate sufficient torque to polish or sand a desired working surface or workpiece, respectively.

The transmission arrangement 56 may be designed such as to reduce the rotational speed of the output adapter 54 in respect to the rotational speed of the input adapter 52, and at the same time to change the type or motion executed by the axial output adapter 54. For instance, depending on the design of the transmission arrangement 56, the tool shaft 18 and the axial input adapter 52 may perform a rotational motion and the axial output adapter 54 may perform one of a gear driven (or forced eccentric) motion, a random-orbital (or free eccentric) and an orbital motion.

Of course, the transmission arrangement could also have a transmission ratio i of i=1 or of i<1. In the case of i=1, the transmission arrangement 56 is designed such as to maintain the rotational speed of the input adapter 52 and to merely change the type or motion executed by the axial output adapter 54. For instance, the tool shaft 18 and the axial input adapter 52 may perform a rotational motion and the axial output adapter 54 may perform one of a gear driven (or forced eccentric) motion, a random-orbital (or free eccentric) and an orbital motion.

In the case of i<1, the transmission arrangement 56 may be designed such as to increase the rotational speed of the axial output adapter 54 in respect to the speed of the axial input adapter 52. At the same time, the torque generated by the output adapter 54 and provided to the backing plate 12, respectively, is smaller than the torque generated by the tool shaft 18 and provided to the input adapter 52, respectively. This may be particularly interesting for high-speed applications which do not need a large amount of torque. The transmission arrangement 56 may be designed such as to increase the rotational speed of the output adapter 54 in respect to the rotational speed of the input adapter 52, and at the same time to change the type or motion executed by the axial output adapter 54. For instance, the tool shaft 18 and the axial input adapter 52 may perform a rotational motion and the axial output adapter 54 may perform one of a gear driven (or forced eccentric) motion and a random-orbital (or free eccentric) motion.

In the embodiment of FIGS. 1 to 5, the transmission arrangement 56 is designed such as to transform a rotary motion of the axial input shaft 52 into a rotary motion of the axial output shaft 54 at a rotational speed differing from the rotational speed of the axial input shaft 52, wherein the rotational axes 30 of the axial input shaft 52 and of the axial output shaft 54 are congruent with one another. Thus, the transmission arrangement 56 is designed such as to maintain the type of motion of the axial input shaft 52 and to simply transfer it to the axial output shaft 54. Preferably, the rotary speed of the axial output shaft 54 is smaller than the rotary speed of the axial input shaft 52, i.e., the transmission ratio i of the transmission arrangement is i>1, and the torque provided by the axial output shaft 54 and provided to the backing plate 12 is larger than the torque provided by the tool shaft 18 of the power tool 10 and the axial input shaft 52 of the working head 50, respectively.

In the embodiment of FIGS. 1 to 5, the transmission arrangement 56 is designed such as to transform the rotary motion of the axial input shaft 52 into the rotary motion of the axial output shaft 54 having the same sense of rotation as the axial input shaft 52.

It is possible (not shown in the Figs.) that the axial input adapter 52 of the working head 50 comprises an axial recess having a non-rotationally symmetric internal cross section including a polygon, in particular in the form of a square, a hexagon or an octagon. The tool shaft 18 of the power tool 10 comprises a shaft-like distal end having a respective non-rotationally symmetric external cross section including a polygon, in particular in the form of a square, a hexagon or an octagon. The axial recess of the axial input adapter 52 of the working head 50 is adapted to receive the shaft-like distal end of the tool shaft 18 of the power tool 10 in the axial direction, in order to establish a torque-proof connection between the tool shaft and the axial input adapter.

Alternatively, as shown in the embodiments of FIGS. 1 to 5 and 7, the axial input adapter 52 of the working head 50 comprises a shaft-like protruding element 68 having a non-rotationally symmetric external cross section including a polygon, in particular in the form of a square, a hexagon or an octagon. The tool shaft 18 of the power tool 10 comprises an axial recess (see FIG. 7) having a respective non-rotationally symmetric internal cross section including a polygon, in particular in the form of a square, a hexagon or an octagon. The shaft-like protruding element 68 of the axial input adapter 52 of the working head 50 is adapted to enter into the axial recess of the distal end of the tool shaft 18 of the power tool 10 in the axial direction, in order to establish a torque-proof connection between the tool shaft and the axial input adapter.

Attachment of the shaft-like protruding element 68 of the axial input adapter 52 of the working head 50 to the tool shaft 18 of the power tool 10 may be performed similar to what is described in prior art references EP 4 450 221 A1 for the releasable attachment of an eccentric element to a tool shaft and EP 4 450 222 A1 for the releasable attachment of a polishing pad to a tool shaft. Both references are incorporated herein by reference in connection with the releasable attachment of the working head 50 (corresponding to the eccentric element of EP'221 and the polishing pad of EP'222) to the tool shaft 18. According to these references, the tool shaft has an axial recess at its distal end, the recess being limited by a hollow cylindrical jacket, and has a plurality of spherical magnetic elements provided in an external wall of the hollow cylindrical jacket of the axial recess in a manner movable in a radial direction. When the shaft-like protruding element 68 made of metal, preferably steel, is inserted into the axial recess of the tool shaft 18, the spherical magnetic elements are attracted by the metal material of the shaft-like protruding element 68 and enter into radial recesses 70 provided on an external surface of the shaft-like protruding element 68.

Of course, other possibilities for the attachment of the shaft-like protruding element 68 of the axial input adapter 52 of the working head 50 to the tool shaft 18 of the power tool 10 are conceivable, too. These other possibilities comprise an embodiment where the shaft-like protruding element 68 is merely inserted into the axial recess of the tool shaft 18. In that case, the axial holding of the shaft-like protruding element 68 in the axial recess of the tool shaft 18 is performed by the magnetic elements 58 of the working head 50 interacting with the respective magnetic elements 60 of the tool housing 16.

Preferably, when attaching the working head 50 to the tool housing 16, the axial input adapter 52 automatically enters into engagement with the distal end of the tool shaft 18 in a torque proof manner. Thus, when the adapter housing 62 of the working head 50 is firmly held in respect to the front part 16b of the tool housing 16 (in a torque-resistant manner) by means of magnetic force, a torque can be transmitted from the tool shaft 18 of the power tool 10 to the input adapter 52 of the working head 50. Attachment and detachment of the working head 50 is straight forward, easy and fail-safe.

According to another preferred embodiment of the quick-change working head 50 according to the present invention it is suggested that the axial output adapter 54 of the working head 50 comprises an axial recess 72 (see FIG. 2a) having a threaded internal wall 74. A fastening pin 76 (see FIG. 2b) is attached to a top surface 78 of the backing plate 12. A shaft-like distal end of the fastening pin 76 or the entire fastening pin 76 has a threaded external surface 80. The axial recess 72 is adapted to receive in a threaded manner the distal end of the fastening pin 76, in order to establish a threaded connection between the backing plate 12 and the axial output adapter 54. When attaching or detaching the backing plate 12 to/from the axial output adapter 54, free rotation of the output adapter 54 should be prevented. This could be achieved by means of a separate tool member (not shown) insertable into the working head 50 and blocking free rotation of the axial output adapter 54, or by means of an integrated braking or blocking device (not shown) which can be activated or deactivated by the user of the working head 50 or the power tool 10, respectively. The braking or blocking device could make part of the working head 50.

Alternatively and not shown in the Figs., the axial output adapter 54 of the working head 50 could also comprise a fastening pin having a shaft-like distal end with a threaded external surface. An axial recess is provided on a top surface 78 of the backing plate 12, the recess having a respective threaded internal wall. The shaft-like distal end of the fastening pin is adapted to be inserted in a threaded manner into the axial recess of the backing plate 12, in order to establish a threaded connection between the backing plate 12 and the axial output adapter 54.

As shown in FIGS. 4 and 5, the transmission arrangement 56 may comprise an epicyclic gear arrangement (or planetary gear set) made up of several components. These comprise a first sun gear wheel, a plurality of (e.g., three) planet gear wheels, a ring gear and a second sun gear wheel. Each planet gear wheel comprise an upper gear wheel and a lower gear wheel attached to the upper gear wheel in a torque proof manner, the upper gear wheels having a larger number of teeth (and consequently a larger diameter) than the lower gear wheels. The first sun gear wheel meshes with the upper gear wheels of the planet gear wheels, and the second sun gear wheel meshes with the lower gear wheels of the planet gear wheels.

In the embodiment shown in FIG. 5, the adapter housing 62 has a cup-shape and is open towards the bottom. The axial input adapter 52 or the shaft-like protruding element 68, respectively, is inserted into the cup-shaped adapter housing 62 through a central through-hole provided in the closed top surface of the adapter housing 62. A proximal end of the input adapter 52 inside the cup-shaped adapter housing 62 opposite the shaft-like protruding element 68 carries the first sun gear wheel 82 (see FIGS. 2a and 7) in a torque proof manner. The first sun gear wheel 82 is not visible in FIG. 5 because it is inside the cup-shaped adapter housing 62.

The first sun gear wheel 82 meshes with the upper gear wheels 84 of the planet gear wheels, which transfer the rotation and torque to the lower gear wheels 86 of the planet gear wheels. The lower gear wheels 86 mesh with the second sun gear wheel 88 attached to the axial output adapter 54 in a torque-proof manner. Additionally, the lower gear wheels 86 also mesh with the external ring gear 90, which is attached to the adapter housing 62. This is also shown in detail in FIG. 7.

Thus, as shown in FIG. 5, the transmission arrangement 56 of the working head 50 comprises two separate components, a first component 56′ comprising a carrier 92 holding the planet gear wheels 84, 86 in a manner freely rotatable and a second component 56″ comprising the external ring gear 90 and holding the second sun gear wheel 88 in a manner freely rotatable. The first component 56′ can be inserted into the cup-shaped adapter housing 62, and the second component 56″ serves as a lid or cover for closing the open side of the cup-shaped adapter housing 62 after insertion of the first component 56′. Attachment of the second component 56″ to the first component 56′ may be achieved by means of a threaded connection, screws, a snap-in connection, a press-fit connection or the like.

The adapter housing 62 preferably comprise two parts. The main part constituting a structural support is indicated with reference sign 62a. The main part 62a is made of a rigid plastic material or metal. The second part 62b may be attached to a front section of the main part 62a of the adapter housing 62 and is preferably made of an elastic or resilient material. It serves as a damping element in order to avoid damage of the working surface to be worked with the power tool 10 or of other parts of the vehicle, boat or aircraft delimiting the working surface during intended use of the power tool 10.

1. A quick-change Quick-change working head (50), which is releasably attachable to a front part (16b) of a tool housing (16) of a hand-held power tool (10), including in particular a polisher or sander, the quick-change working head (50) comprising an axial input adapter (52) releasably connectable to a tool shaft (18) of the hand-held power tool (10), an axial output adapter (54) releasably connectable to a working element (12), including in particular a backing plate, of the hand-held power tool (10) and a transmission arrangement (56) with a specific transmission ratio (i), the transmission arrangement (56) functionally located between the axial input adapter (52) and the axial output adapter (54) and adapted to make the axial output adapter (54) rotate at a given speed depending on the rotational speed of the axial input adapter (52) and the transmission ratio (i) of the transmission arrangement (56), wherein characterized in that
the quick-change working head (50) comprises magnetic elements (58), including one or more permanent magnets and/or one or more ferromagnetic elements, the magnetic elements (58) being adapted to magnetically interact with respective magnetic elements (60), including the one or more permanent magnets and/or the one or more ferromagnetic elements, located in the front part (16b) of the tool housing (16) of the hand-held power tool (10) once the quick-change working head (50) is close to the front part (16b) of the tool housing (16) during attachment of the quick-change working head (50) to the front part (16b) of the tool housing (16) of the hand-held power tool (10), wherein the magnetic interaction between the magnetic elements (58) of the working head (50) and the respective magnetic elements (60) of the front part (16b) of the tool housing (16) ensures that the quick-change working head (50) is firmly held in respect to the front part (16b) of the tool housing (16) in an axial direction extending parallel to a rotational axis (30) of the axial input adapter (52).

2. The quick-change working head (50) according to claim 1, wherein the quick-change working head (50) comprises mechanical positioning means (64) being adapted to mechanically interact with respective mechanical positioning means (66) located in the front part (16b) of the tool housing (16) of the hand-held power tool (10) once the quick-change working head (50) is attached to the front part (16b) of the tool housing (16) of the hand-held power tool (10), wherein the mechanic interaction between the mechanical positioning means (64) of the quick-change_working head (50) and the respective mechanical positioning means (66) of the front part (16b) of the tool housing (16) holds the quick-change working head (50) in respect to the front part (16b) of the tool housing (16) in a circumferential direction extending in a plane perpendicular to the rotational axis (30) of the axial input adapter (54) in a specific angular position.

3. The quick-change working head (50) according to claim 2, wherein the mechanical positioning means (64) of the quick-change working head (50) have an exclusively axial extension extending parallel to the rotational axis (30) of the axial input adapter (52).

4. The quick-change working head (50) according to claim 1, wherein the transmission arrangement (56) has a transmission ratio (i) of i>1, in particular of i>1,5, particularly preferred of i≥2, in particular of i=2,36, thereby reducing speed and increasing torque of the axial output adapter (54) in respect to the speed and torque of the axial input adapter (52).

5. The quick-change working head (50) according to claim 1, wherein the transmission arrangement (56) is designed such as to transform a rotary motion of the axial input shaft (52) into a rotary motion of the axial output shaft (54) at a rotational speed differing from the rotational speed of the axial input shaft (52), wherein the rotational axes (30) of the axial input shaft (52) and of the axial output shaft (54) are congruent with one another.

6. The quick-change working head (50) according to claim 5, wherein the transmission arrangement (56) is designed such as to transform the rotary motion of the axial input shaft (52) into the rotary motion of the axial output shaft (54) having the same sense of rotation as the axial input shaft (52).

7. The quick-change working head (50) according to claim 1, wherein the axial input adapter (52) of the quick-change working head (50) comprises an axial recess having a non-rotationally symmetric internal cross section including a polygon, including in the form of a square, a hexagon or an octagon, and adapted for receiving a shaft-like distal end of the tool shaft (18) of the hand-held power tool (10) in the axial direction, in order to establish a torque-proof connection between the tool shaft (18) and the axial input adapter (52).

8. The quick-change working head (50) according to claim 1, wherein the axial input adapter (52) of the quick-change working head (50) comprises a shaft-like protruding element (68) having a non-rotationally symmetric external cross section including a polygon, including in the form of a square, a hexagon or an octagon, and adapted for entering into an axial recess of a distal end of the tool shaft (18) of the hand-held power tool (10) in the axial direction, in order to establish a torque-proof connection between the tool shaft (18) and the axial input adapter (52).

9. The quick-change working head (50) according to claim 1, wherein the axial output adapter (54) of the quick-change working head (50) comprises an axial recess (72) having a threaded internal wall (74) and adapted for receiving in a threaded manner a shaft-like distal end of a fastening pin (76) attached to a top surface (78) of the backing plate (12) and having a threaded external surface (80), in order to establish a threaded connection between the backing plate (12) and the axial output adapter (54).

10. The quick-change working head (50) according to claim 1, wherein the axial output adapter (54) of the quick-change working head (50) comprises a fastening pin having a threaded external surface and adapted for being inserted in a threaded manner into an axial recess provided on a top surface (78) of the backing plate (12) and having a threaded internal wall, in order to establish a threaded connection between the backing plate (12) and the axial output adapter (54).

11. A hand-held power tool (10), including a polisher or sander, having a tool housing (16) and a quick-change working head (50) releasably attachable to a front part (16b) of the tool housing (16) of a hand-held power tool (10), the quick-change working head (50) comprising an axial input adapter (52) releasably connectable to a tool shaft (18) of the hand-held power tool (10), an axial output adapter (54) releasably connectable to a working element (12), including a backing plate, of the hand-held power tool (10) and a transmission arrangement (56) with a specific transmission ratio (i), the transmission arrangement (56) functionally located between the axial input adapter (52) and the axial output adapter (54) and adapted to make the axial output adapter (54) rotate at a given speed depending on the rotational speed of the axial input adapter (52) and the transmission ratio (i) of the transmission arrangement (56),
wherein
the quick-change working head (50) comprises magnetic elements (58), including one or more permanent magnets and/or one or more ferromagnetic elements, and the front part (16b) of the tool housing (16) of the hand-held power tool (10) comprises respective magnetic elements (60), including the one or more permanent magnets and/or the one or more ferromagnetic elements, the magnetic elements (58) being adapted to magnetically interact with the respective magnetic elements (60) once the quick-change working head (50) is close to the front part (16b) of the tool housing (16) during attachment of the quick-change working head (50) to the front part (16b) of the tool housing (16) of the hand-held power tool (10), wherein the magnetic interaction between the magnetic elements (58) of the quick-change working head (50) and the respective magnetic elements (60) of the front part (16b) of the tool housing (16) ensures that the quick-change working head (50) is firmly held in respect to the front part (16b) of the tool housing (16) in an axial direction extending parallel to a rotational axis (30) of the axial input adapter (52).

12. The hand-held power tool (10) according to claim 11, wherein the quick-change_working head (50) comprises mechanical positioning means (64) being adapted to mechanically interact with respective mechanical positioning means (66) located in the front part (16b) of the tool housing (16) of the hand-held power tool (10) once the quick-change working head (50) is attached to the front part (16b) of the tool housing (16) of the hand-held power tool (10), wherein the mechanic interaction between the mechanical positioning means (64) of the quick-change working head (50) and the respective mechanical positioning means (66) of the front part (16b) of the tool housing (16) holds the quick-change working head (50) in respect to the front part (16b) of the tool housing (16) in a circumferential direction extending in a plane perpendicular to the rotational axis (30) of the axial input adapter (52) in a specific angular position.

13. The hand-held power tool (10) according to claim 12, wherein the mechanical positioning means (64) of the quick-change working head (50) and the respective mechanical positioning means (66) of the front part (16b) of the tool housing (16) have an exclusively axial extension extending parallel to the rotational axis (30) of the axial input adapter (52).

14. The hand-held power tool (10) according to claim 11, wherein the axial input adapter (52) of the quick-change working head (50) comprises an axial recess having a non-rotationally symmetric internal cross section, including a polygon in the form of a square, a hexagon or an octagon, the tool shaft (18) of the hand-held power tool (10) comprises a shaft-like distal end having a respective non-rotationally symmetric external cross section, including a polygon in the form of a square, a hexagon or an octagon, and the axial recess of the axial input adapter (52) of the quick-change working head (50) is adapted to receive the shaft-like distal end of the tool shaft (18) in the axial direction, in order to establish a torque-proof connection between the tool shaft (18) and the axial input adapter (52).

15. The hand-held power tool (10) according to claim 11, wherein the axial input adapter (52) of the quick-change working head (50) comprises a shaft-like protruding element (68) having a non-rotationally symmetric external cross section, including a polygon in the form of a square, a hexagon or an octagon, a distal end of the tool shaft (18) of the hand-held power tool (10) comprises an axial recess having a non-rotationally symmetric internal cross section, including a polygon in the form of a square, a hexagon or an octagon, and the shaft-like protruding element (68) of the axial input adapter (52) is adapted to enter into the axial recess of the distal end of the tool shaft (18) in the axial direction, in order to establish a torque-proof connection between the tool shaft (18) and the axial input adapter (52).

16. The hand-held power tool (10) according to claim 11, wherein the hand-held power tool (10) comprises a quick-change working head (50), which is releasably attachable to a front part (16b) of a tool housing (16) of a hand-held power tool (10), including a polisher or sander, the quick-change working head (50) comprising an axial input adapter (52) releasably connectable to a tool shaft (18) of the hand-held power tool (10), an axial output adapter (54) releasably connectable to a working element (12), including a backing plate, of the hand-held power tool (10) and a transmission arrangement (56) with a specific transmission ratio (i), the transmission arrangement (56) functionally located between the axial input adapter (52) and the axial output adapter (54) and adapted to make the axial output adapter (54) rotate at a given speed depending on the rotational speed of the axial input adapter (52) and the transmission ratio (i) of the transmission arrangement (56), characterized in that the quick-change working head (50) comprises magnetic elements (58), including one or more permanent magnets and/or one or more ferromagnetic elements, the magnetic elements (58) being adapted to magnetically interact with respective magnetic elements (60), including the one or more permanent magnets and/or the one or more ferromagnetic elements, located in the front part (16b) of the tool housing (16) of the hand-held power tool (10) once the quick-change working head (50) is close to the front part (16b) of the tool housing (16) during attachment of the quick-change working head (50) to the front part (16b) of the tool housing (16) of the hand-held power tool (10), wherein the magnetic interaction between the magnetic elements (58) of the quick-change working head (50) and the respective magnetic elements (60) of the front part (16b) of the tool housing (16) ensures that the quick-change working head (50) is firmly held in respect to the front part (16b) of the tool housing (16) in an axial direction extending parallel to a rotational axis (30) of the axial input adapter (52).

17. The quick-change working head (50) according to claim 2, wherein the transmission arrangement (56) has a transmission ratio (i) of i>1, in particular of i>1,5, particularly preferred of i≥2, in particular of i=2,36, thereby reducing speed and increasing torque of the axial output adapter (54) in respect to the speed and torque of the axial input adapter (52).

18. The quick-change working head (50) according to claim 2, wherein the transmission arrangement (56) is designed such as to transform a rotary motion of the axial input shaft (52) into a rotary motion of the axial output shaft (54) at a rotational speed differing from the rotational speed of the axial input shaft (52), wherein the rotational axes (30) of the axial input shaft (52) and of the axial output shaft (54) are congruent with one another.

19. The quick-change working head (50) according to claim 2, wherein the axial input adapter (52) of the working head (50) comprises an axial recess having a non-rotationally symmetric internal cross section including a polygon, in the form of a square, a hexagon or an octagon, and adapted for receiving a shaft-like distal end of the tool shaft (18) of the hand-held power tool (10) in the axial direction, in order to establish a torque-proof connection between the tool shaft (18) and the axial input adapter (52).

20. The quick-change working head (50) according to claim 2, wherein the axial input adapter (52) of the working head (50) comprises a shaft-like protruding element (68) having a non-rotationally symmetric external cross section including a polygon, in the form of a square, a hexagon or an octagon, and adapted for entering into an axial recess of a distal end of the tool shaft (18) of the hand-held power tool (10) in the axial direction, in order to establish a torque-proof connection between the tool shaft (18) and the axial input adapter (52).

21. The quick-change working head (50) according to claim 1, wherein the quick-change working head (50) has an adapter housing (62) in which the axial input adapter (52), the axial output adapter (54) and the transmission arrangement (56) are rotatably mounted,
wherein the axial input adapter (52) is adapted to rotate about the rotational axis (30), and
wherein the magnetic elements (58) are part of or attached to the adapter housing (62) of the quick-change working head (50) and not part of the axial input adapter (52) of the quick-change working head (50).

22. The hand-held power tool (10) according to claim 11, wherein the quick-change working head (50) has an adapter housing (62) in which the axial input adapter (52), the axial output adapter (54) and the transmission arrangement (56) are rotatably mounted,
wherein the tool shaft (18) and the axial input adapter (52) are both adapted to rotate about the rotational axis (30), and
wherein the magnetic elements (58) are part of or attached to the adapter housing (62) of the quick-change working head (50) and not part of the axial input adapter (52) of the quick-change working head (50), and the respective magnetic elements (60) are part of or attached to the tool housing (16) of the hand-held power tool (10) and not part of the tool shaft (18) of the hand-held power tool (120).
